(19) United States
(12) Patent Application Publication
(10) Pub. No.: US 2009/0328171 A1
(43) Pub. Date: Dec. 31, 2009

(54) Method and system for secure remote storage of electronic media

(75) Inventors: Victor A. Bayus, Decatur, GA (US); Anthony C. Salvo, Westford, MA (US)

Correspondence Address: KING & SPALDING, 1180 PEACHTREE STREET , NE, ATLANTA, GA, 30309-3521, US

(73) Assignee: SI Corporation, Norcross, GA (US)

(21) Appl. No.: 12/154,632

(22) Filed: May 23, 2008

Related U.S. Application Data
(60) Provisional application No. 60/931,823, filed on May 25, 2007.

(51) Int. Cl. H04L 9/32; G06F 21/00

(52) U.S. Cl. 726/7; 726/26

(57) ABSTRACT

Secure remote storage of electronic media. A virtual safe application resides on a server and provides for encrypted storage, display, and access to critical electronic media. The virtual safe communicates with trusted entities, which can automatically populate the virtual safe with pre-selected types of files into pre-selected locations. A user can access the virtual safe over a network to customize the display, manage files, upload files, and/or share files. Sharing a file grants selected access rights to a selected file by another authorized user. The shared file is displayed on the interface associated with the other authorized user, allowing the other user to view the file and to perform functionality consistent with the access rights. The sharing capability facilitates communication for use in streamlining business and/or personal matters. The virtual safe thus provides access to documents anytime, anywhere, while ensuring security, facilitating communication, and eliminating manual steps.

### RELATED PATENT APPLICATIONS

This non-provisional patent application claims priority under 35 U.S.C. §119 to U.S. Provisional Patent Application No. 60/931,823, titled “Method And System For Secure Remote Storage Of Electronic Media,” filed May 25, 2007. The complete disclosure of this provisional application is hereby fully incorporated herein by reference.

### TECHNICAL FIELD

This invention relates to systems and methods for remote storage of electronic media. More particularly, this invention relates to processes and systems that allow for efficient storage and sharing of critical electronic media in a virtual safe as well as automatic uploading of electronic media into the virtual safe.

### BACKGROUND

The requirement for secure storage of critical documents, such as bank statements, certificates of title, wills, and insurance contracts is ever-present. Traditional methods of storage include the use of a physical vault or safety deposit box. With these methods, a user would store physical copies of important documents in a vault in a secure location within their home or at a safety deposit box at a bank. To access the documents, a user would be required to have a key or other identification to open the vault and would be required to travel to the location of the vault. Home storage of such documents risks loss in the event of a fire or another type of disaster and further does not ensure security. Storage in a safety deposit box involves a time-consuming process to access the documents and/or add additional documents. Further, access generally is limited to only one authorized user.

Other conventional methods of securing important documents include storing an electronic copy of the document. Such conventional methods include, for example, storing electronic copies on the owner's hard drive or on a back up hard drive. With this conventional method, the electronic documents are not securely stored; and access to the hard drive is not secure. As with storage of physical documents in the home, the stored documents are subject to loss in the event of a disaster and are subject to security breaches if unauthorized users can access the computer system. Further, even if the electronic documents are stored in a remote location, the transmission of electronic documents is not secured. Additionally, such conventional methods do not allow for user control of the organization of such data, and/or the ability to share data with other users. Other issues with such conventional methods include the inability for a user to centrally locate all critical electronic media; the requirement to manually upload new electronic media; and the inability of the user to control aspects of the electronic media, including access by other users, organization, and length of storage.

Thus, a need exists in the art for secure, remote storage of electronic media that overcomes the problems listed above.

### SUMMARY

The invention supports systems and methods for secure, remote storage of electronic media in a “virtual safe.” The term “virtual safe” is used herein to describe the secure remote storage application that can receive electronic media and store it in a file storage device, where it is associated with a particular user. Each user having a virtual safe account has access to a predetermined amount of storage space. Only the user associated with the virtual safe, and certain other authorized and approved entities, have access to the electronic media associate with the user's virtual safe. The virtual safe also provides a user interface at an access point, such as a website, that allows users to quickly and easily view, organize, and perform other functionality related to important documents stored as electronic media.

The virtual safe thus provides users with access to space to store critical documents that can be accessed immediately, anytime, anywhere, through a workstation connected to a network. For example, the user can access critical documents, such as a passport, a bank statement, and/or a certificate of title, quickly and easily from almost any location, while ensuring its security. Specifically, the invention can provide systems and methods for securely storing electronic media with a trusted entity, while allowing for user customization of the organization, display, and length of time the electronic media is stored. In addition, the invention supports methods to allow for auto-population of the virtual safe from trusted entities, such as a bank. In this way, the virtual safe can automatically receive electronic media, and store the media in a file storage device. This feature can eliminate many of the manual steps involved with conventional systems. Further, the user can upload electronic media to the virtual safe from the user's hard drive and/or another location. In addition, a user can approve other users with whom to share certain electronic media. The invention thus provides the ability to easily share sensitive documents with only approved sharees while limiting the approved sharee's ability to modify, move, or download the shared item.

In one aspect of the invention, a method for remote secure storage of electronic media can include the step of receiving electronic media. For example, electronic media can be received from a user's hard drive or from a trusted entity, such as a bank. Methods to receive the files can include file transfer over the network, files attached to an e-mail sent to a specific address, or through receipt of a document via facsimile transmission. The receiving step can be automated, such that electronic media from a trusted entity is automatically uploaded. The method also includes the step of storing the electronic media in a file storage device. The files can be encrypted when stored to increase security. The method also can include the step of preventing access to the electronic media from unauthorized users. For example, only authorized users will have valid logon information, which will provide access to the electronic media. The method also provides for customizing a display of the electronic media. For example, the user can create custom files, folders, and categories to facilitate organization of the electronic media. Further, the method provides for the step of sharing a subset of the electronic media with an approved sharee. The user can grant access to an approved sharee of a selected file and/or folder. In addition, the user can restrict the access rights the approved sharee will have with regard to the file and/or folder.

In another aspect of the invention, a system for remote secure storage of electronic media includes an application server configured to receive electronic media associated with an authorized user. The electronic media can be received automatically from a trusted entity. The system also includes an authorization engine configured to prevent access to the electronic media by an unauthorized user. In addition, the system includes access points that are logically connected to the application server and configured to display information associated with the electronic media. The access points also can receive instructions from an authorized user relating to sharing an item of electronic media with another authorized user. Further, the system includes a file storage device that is logically connected to the application server and that can store the electronic media.

In yet another aspect of the invention, a method for remote secure storage of electronic media includes the step of storing electronic media in a file storage device. The method further includes displaying content associated with the electronic media on a display that is accessible by an authorized user. In addition, the method includes the steps of receiving instructions associated with the electronic media from the authorized user and preventing access to the electronic media from unauthorized users. Further, the method includes the step of customizing the display of the electronic media and automatically uploading a predetermined subset of the electronic media from a trusted entity to a predetermined location in the file storage device. The method also can include the step of facilitating communication among one or more authorized users. This step includes providing access by one authorized user to another authorized user to selected files and/or folders and restricting the access rights to the files and/or folder.

Thus, the virtual safe can provide secure storage and efficient access to critical documents anytime, anywhere, while facilitating communication by sharing capabilities and eliminating manual uploading steps.

These and other aspects, objects, and features of the invention will become apparent to those having ordinary skill in the art upon consideration of the following detailed description of exemplary embodiments exemplifying the best mode for carrying out the invention as presently perceived.

### BRIEF DESCRIPTION OF THE DRAWINGS

FIG. 1 is a block diagram depicting a system architecture for secure remote storage of electronic media, in accordance with an exemplary embodiment of the invention.

FIG. 2 is a flow chart depicting a method for secure remote storage of electronic media, in accordance with an exemplary embodiment of the invention.

FIG. 3 is a flow chart depicting a method for creating and populating a virtual safe, in accordance with an exemplary embodiment of the invention.

FIG. 4 is a flow chart depicting a method for providing a file management dashboard, in accordance with an exemplary embodiment of the invention.

FIG. 5 is a flow chart depicting a method for providing a product administration dashboard, in accordance with an exemplary embodiment of the invention.

FIG. 6 is a flow chart depicting a method for customizing the dashboard display, in accordance with an exemplary embodiment of the invention.

FIG. 7 is a flow chart depicting a method for managing files, in accordance with an exemplary embodiment of the invention.

FIG. 8 is a flow chart depicting a method for administering sharees, in accordance with an exemplary embodiment of the invention.

FIG. 9 is a flow chart depicting a method for sharing and/or unsharing files and/or folders, in accordance with an exemplary embodiment of the invention.

FIG. 10 is a screenshot depicting a representative display of the file management dashboard, in accordance with an exemplary embodiment of the invention.

### DETAILED DESCRIPTION OF THE EXEMPLARY EMBODIMENTS

A virtual safe application resides on a server and provides for encrypted storage, display, and access to electronic media. The virtual safe can receive the electronic media and store it in a file storage device based on user information. The virtual safe communicates with trusted entities, which can automatically populate the virtual safe with pre-selected types of files into pre-selected locations. A user can access the virtual safe over a network to customize the display, manage files, upload files, and/or share files. Sharing a file grants selected access rights to a selected file by another authorized user. The shared file is displayed on the interface associated with the other authorized user, allowing the other user to view the file and perform functionality consistent with the access rights. The sharing capability facilitates communication, for use in streamlining business and/or personal matters. The virtual safe thus provides access to critical documents anytime, anywhere, while ensuring security, facilitating communication, and eliminating manual steps. The virtual safe application can run as a stand-alone offering, or integrated with an external internet portal, such as a banking or financial website. Further, the application can allow for users to access accounts with a single-sign-on, without the need to re-enter logon information.

The invention includes a computer program that embodies the functions described herein and illustrated in the appended flow charts. However, it should be apparent that there could be many different ways of implementing the invention in computer programming, and the invention should not be construed as limited to any one set of computer program instructions. Further, a programmer having ordinary skill in the art would be able to write such a computer program to implement an embodiment of the disclosed invention based on the flow charts and associated description in the application text. Therefore, disclosure of a particular set of program code instructions is not necessary for an adequate understanding of how to make and use the invention. The inventive functionality of the claimed computer program will be explained in more detail in the following description read in conjunction with the figures illustrating the program flow.

Turning now to the drawings, in which like numerals indicate like elements throughout the figures, exemplary embodiments of the invention are described in detail.

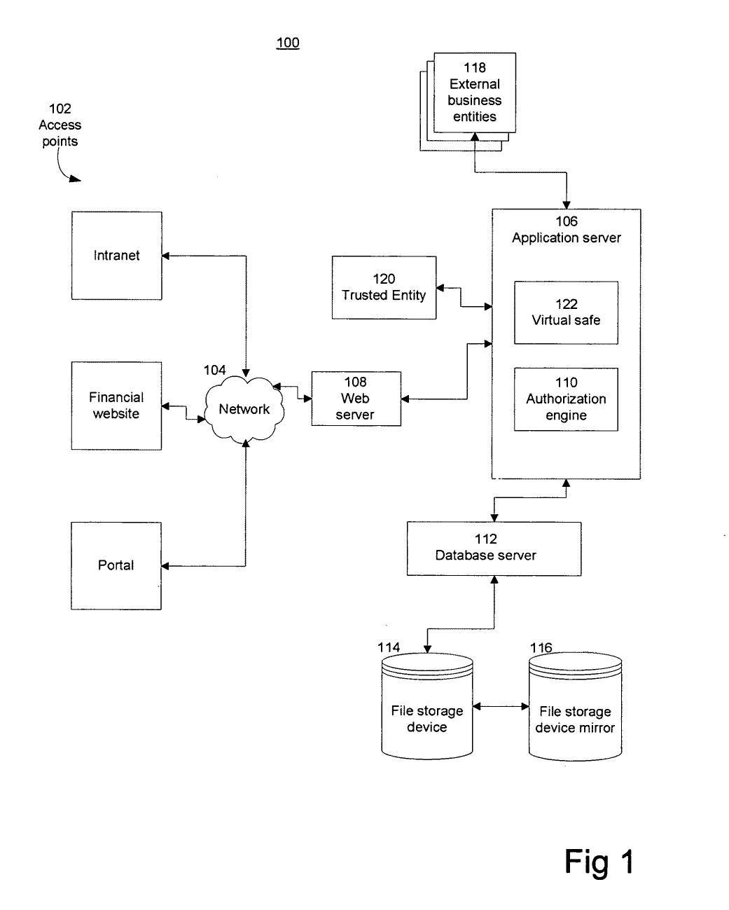

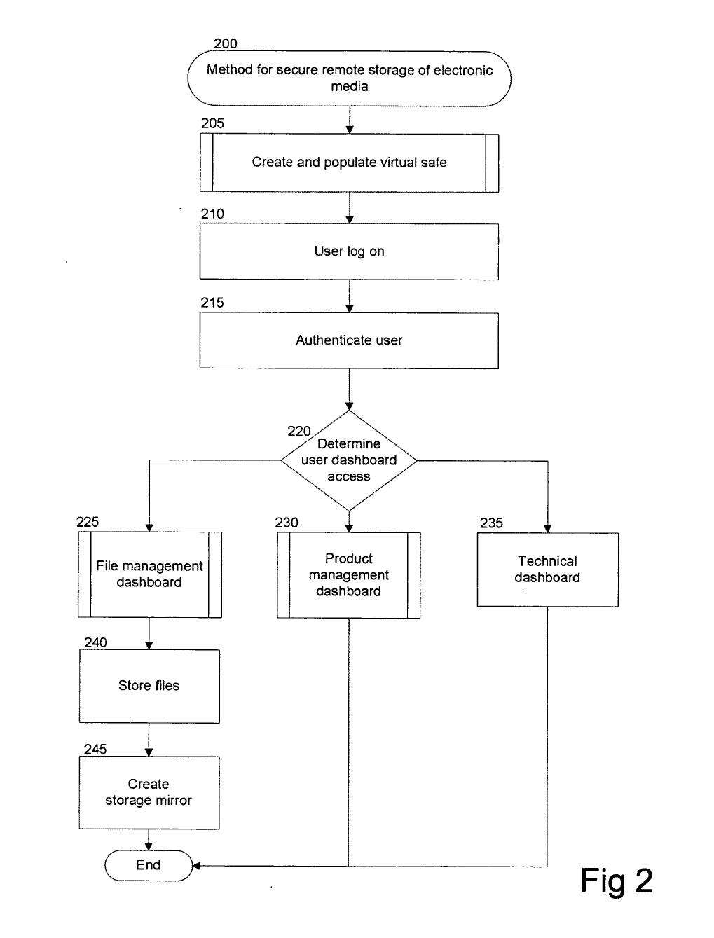

FIG. 1 is a block diagram depicting a system 100 for secure remote storage of electronic media, in accordance with an exemplary embodiment of the invention. The system 100 is described hereinafter with reference to FIGS. 2-10.

FIG. 2 is a flow chart depicting a method 200 for secure remote storage of electronic media, in accordance with an exemplary embodiment of the invention. The exemplary method 200 is illustrative and, in alternative embodiments of the invention, certain steps can be performed in a different order, in parallel with one another, or omitted entirely, and/or certain additional steps can be performed without departing from the scope and spirit of the invention. The method 200 is described hereinafter with reference to FIGS. 1-5 and 10.

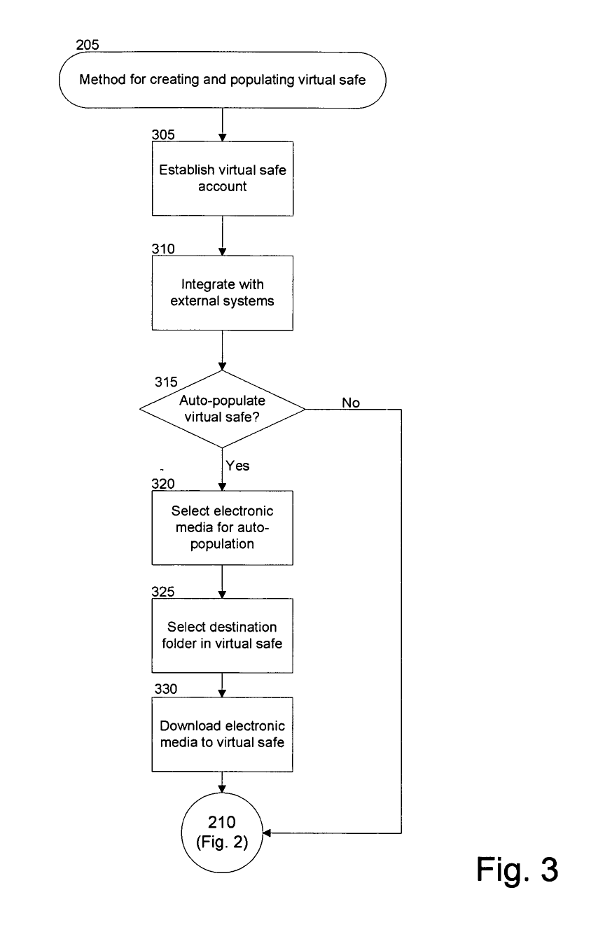

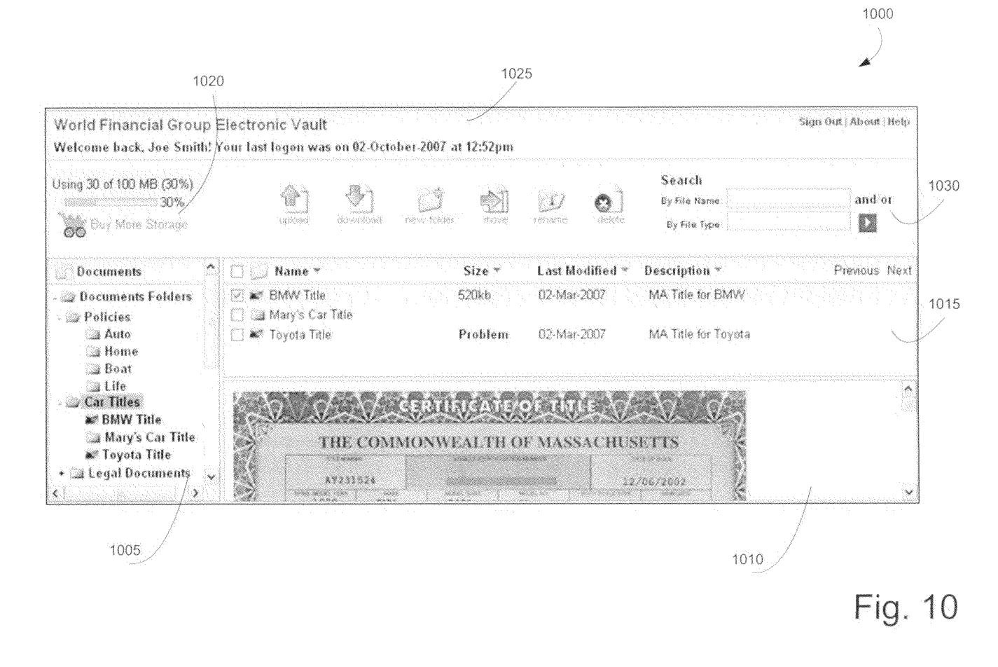

In step 205, a user and/or a system administrator, in conjunction with a trusted entity 120, creates and populates a virtual safe 122. The virtual safe 122 is an application operating on the application server 106. The term “virtual safe” is used herein to describe the secure remote storage application that can access and store electronic media in a file storage device 114. Each authorized user of the virtual safe 122 is allotted a predetermined amount of storage space by the application server 106, on the file storage device 114 and a file storage device mirror 116. Each authorized user is associated with a respective account, and only the authorized user of an account can access electronic media associated with the user's account. The electronic media associated with each user is stored in the file storage device 114 based on the user logon identification. The virtual safe 122 also provides a user interface at an access point 102 that allows users to quickly and easily view, organize, and perform other functionality related to important documents stored as electronic media in the file storage device 114. The display 1000 provided to users of the virtual safe 122 will be described in more detail hereinafter with reference to FIG. 10. The method 205 is described in more detail hereinafter with reference to FIG. 3.

In step 210, an authorized user logs on to the application server 106. The user can access the application server 106, which contains the virtual safe 122, via access points 102, to enter a user logon identification and password. Access points 102 can include a variety of network enabled sites, such as an intranet, a link from a financial website, or any other suitable portal for accessing an application server in a client-server architecture. The access points communicate with a web server 108 via a network 104. The web server 108 communicates with the application server 106.

The application server 106 stores and operates the virtual safe 122 that performs the functionality for remote storing of electronic media described herein. In an exemplary embodiment, the application server 106 is operated under the control of a trusted entity 120. A trusted entity 120 is, for example, a bank, an insurance company, and/or another type of trusted business entity. In this exemplary embodiment, users have confidence in storing critical electronic media in the virtual safe 122 because it is under the control of a trusted entity 120; the trusted entity 120 has the proven ability to secure access to electronic media stored under its control.

In step 215, an authorization engine 110 operating on the application server 106 authenticates the user logon information entered in step 210. Upon entry of the user logon information in step 210, the application server 106 accesses the authorization engine 110. The authorization engine 110 stores the user logon information, including identification and password, (or retrieves user logon information stored in the file storage device 114) and can determine the accuracy of the logon information. Accordingly, only those users who have entered valid logon information, according to the authorization engine 110, are authenticated in step 215. An authenticated user can proceed with access to the virtual safe 122. The virtual safe 122 can thus access electronic media associated with the user stored in the file storage device 114.

In step 220, the user, in conjunction with the authorization engine 110, determines the user dashboard access to the virtual safe 122. Certain users will have access only to a file management dashboard, and will not have a choice of other types of dashboard access. Such users are typically customers of a bank. Other users can have access to a product management dashboard and/or a technical dashboard. Such users are typically administrators of the virtual safe 122. The access to each dashboard is determined by the user logon information and access rights associated therewith and is stored in the authorization engine 110.

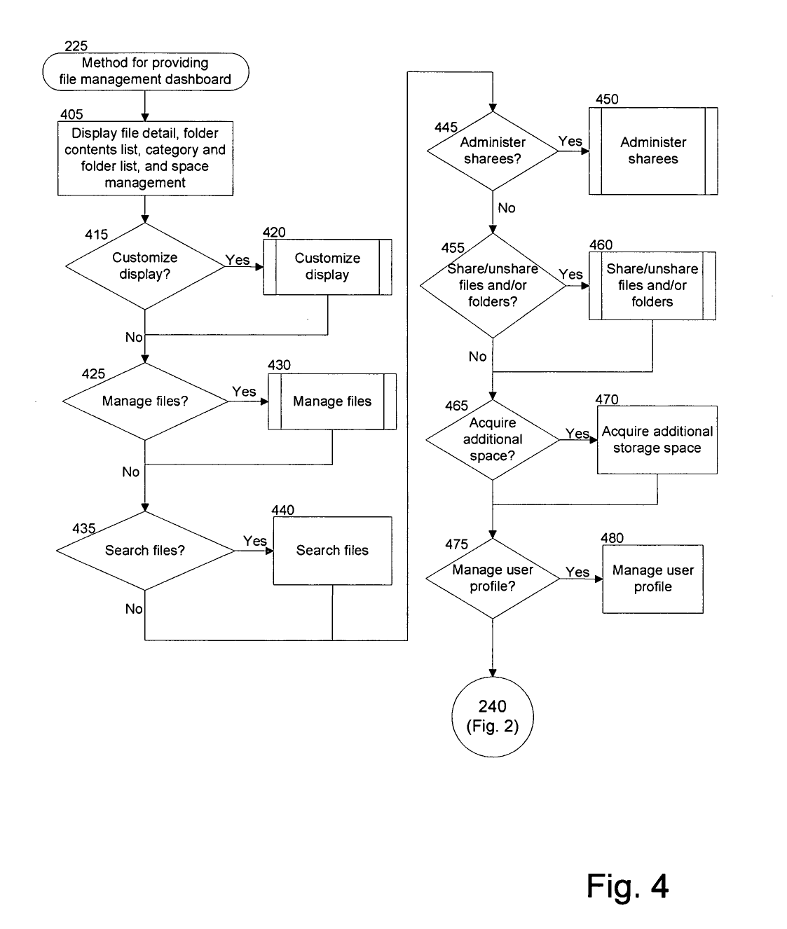

If, in step 220, the determination is made (based on the access rights associated with the user) to access the file management dashboard, the method 200 proceeds to step 225. Step 225 is described in more detail hereinafter with reference to FIG. 4. The method 200 then proceeds to step 240 described hereinafter.

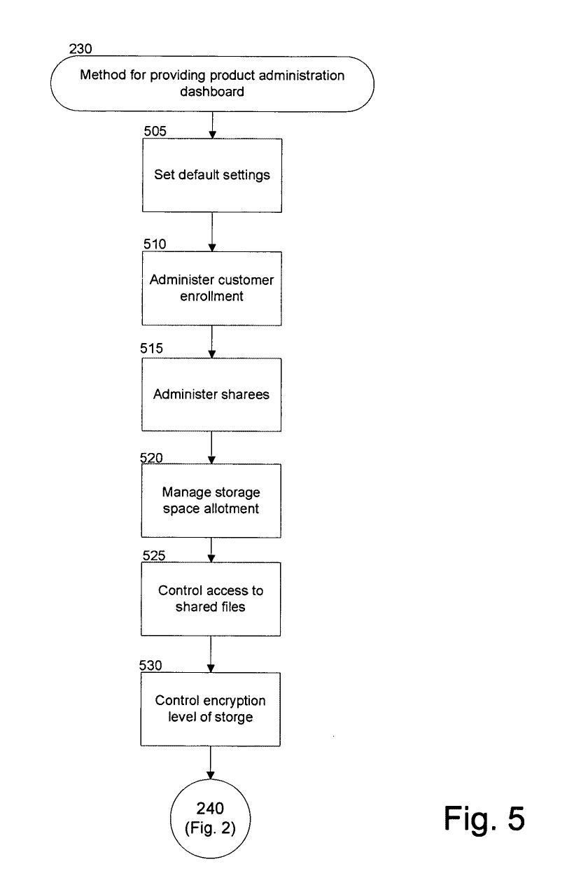

Referring back to step 220, if the determination is made (based on the access rights associated with the user) to access the product management dashboard, the method 200 proceeds to step 230. Step 230 will be described in more detail hereinafter with reference to FIG. 5.

Referring back to step 220, if the determination is made (based on the access rights associated with the user) to access the technical dashboard, the method 200 proceeds to step 235. In step 235, a technical administrator can manage the technical aspects of the components of the system 100. For example, a technical administrator can administer the web server 108, the application server 106, the database server 112, and the other components and connectivity of the elements contained in the system 100 of FIG. 1. For example, the technical administrator can adjust the frequency of storage backups and/or add a disaster recovery mechanism.

In step 240, the application server 106 stores files accessed by the virtual safe 122 in the file storage device 114. The application server 106 is in communication with a database server 112, which manages the storage of files, and is in communication with the file storage device 114. The electronic files stored in the file storage device 114 are stored in an encrypted format to ensure security of the information. The configurability of the level of encryption is discussed in more detail hereinafter with reference to step 530 of FIG. 5. Further, the electronic media is stored based on the user logon identification and/or based on sharee information. User logon information was described in more detail above with reference to step 210. Sharee information will be described hereinafter with reference to FIGS. 4, 8, and 9.

In step 245, the database server 112 creates a storage mirror. In this step, the data contained in the file storage device 114 is replicated to a file storage device mirror 116. In an exemplary embodiment, step 245 also can include frequent storage backups and disaster recovery mechanisms.

In exemplary embodiments, the file storage device 114 and/or the file storage device mirror 116 can be integral components of the database server 112. In alternative exemplary embodiments, the devices 114 and 116 can be separate storage mechanisms.

FIG. 3 is a flow chart depicting a method 205 for creating and populating a virtual safe 122 as referenced in step 205 of FIG. 3, in accordance with an exemplary embodiment of the invention. The exemplary method 205 is illustrative and, in alternative embodiments of the invention, certain steps can be performed in a different order, in parallel with one another, or omitted entirely, and/or certain additional steps can be performed without departing from the scope and spirit of the invention. The method 205 is described hereinafter with reference to FIGS. 1 and 2.

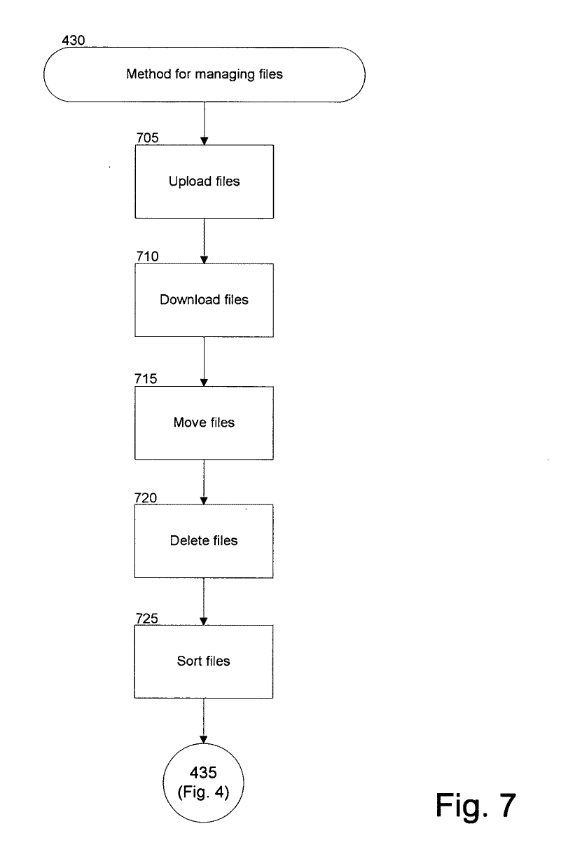

In step 305, the user and/or administrator establishes the virtual safe 122 account. As described herein with reference to step 210 of FIG. 2, the user can access the application server 106 by way of the access points 102, which are logically connected to the application server 106 by a network 104. In an exemplary embodiment, the user and/or an administrator can access the functionality to establish the virtual safe 122 from an access point 102 such as a link from the user's bank's website. In step 305, the user enters personal identification information, such as the user's name, contact information, and account information. Further, the user can register an email address, a facsimile number, and/or a bar code, which will be associated with the user's account. Use of the email address, facsimile, and/or bar code provides for additional uploading options, as will be described hereinafter with reference to FIG. 7. In addition, the user establishes a logon identification and password. The authorization engine 110 stores the logon information, for authentication purposes, as described herein with reference to step 215 of FIG. 2. In addition, if a fee is required to establish a virtual safe 122, the user pays the fee in step 305. By establishing a virtual safe 122 account, the user has access to a predetermined amount of storage space on the application server 106, as well as storage space on the file storage device 114 and the file storage device mirror 116. The application server 106 can access the file storage device 114, which is logically connected to the file storage device mirror 116, by way of a database server 112.

In step 310, the application server 106 integrates the virtual safe 122 account (established in step 305) with the user's account at the trusted entity 120. For example, if the trusted entity 120 is the user's bank, the application server 106 associates the user's financial account at the bank with the virtual safe 122 account established in step 305. Optionally, the application server 106 can integrate with the user's other accounts at external business entities 118, such as insurance companies. In another embodiment, the user does not need to have an account with the trusted entity 120 in order to establish a virtual safe 122 account. In this embodiment, the user can still access the virtual safe 122 account, but the account will not be associated with an account with the trusted entity 120.

In step 315, the user and/or an administrator determines whether to establish auto-population of the virtual safe 122. Auto-population of the virtual safe 122 is an automatic upload of certain electronic media, such as bank statements, into the virtual safe 122. More specifically, the virtual safe 122 automatically receives the electronic media and stores it in a pre-selected folder in the user's allotted space within the file storage device 114. Auto-population eliminates manual steps traditionally associated with displaying and storing such documents, i.e. requiring a user to logon to the bank's website, search for the document, and then upload it. In this embodiment, a user need only logon to the user's virtual safe 122 account to view such documents that have been automatically stored in the appropriate location.

If, in step 315, the determination is made to establish auto-population, the method proceeds to step 320.

In step 320, the user and/or administrator selects which type of electronic media will be auto-populated into the virtual safe 122. For example, the electronic media can include all monthly bank statements. As yet another example, the electronic media can include all credit card statements that exceed a certain amount.

In step 325, the user selects which folder within the virtual safe 122 to which the electronic media selected in step 320 will be uploaded. For example, the user may have a folder entitled “Monthly Bank Statements,” to which all bank statements selected for auto-population will be uploaded.

In step 330, the application server 106 uploads the electronic media selected in step 320 to the folder selected in step 325, as the electronic media comes available from the trusted entity 120. The uploaded files are stored in the file storage device 114, and displayed on the interface provided by the virtual safe 122. In an exemplary embodiment, the virtual safe 122 provides a batch interface to automatically upload information directly from the trusted entity 122. The batch interface capability reduces traditional manual steps. In an alternative embodiment, the auto-population steps described herein with reference to steps 320-330 can apply to external business entities 118 as well. In this alternative embodiment, external business entities 118 can be integrated with the application server 106 to automatically upload electronic media as described above. The method proceeds to step 210 of FIG. 2.

Referring back to step 315, if the determination is made not to establish auto-population, the method proceeds to step 210 of FIG. 2.

FIG. 4 is a flow chart depicting a method 225 for providing a file management dashboard as referenced in step 225 of FIG. 3, in accordance with an exemplary embodiment of the invention. The exemplary method 225 is illustrative and, in alternative embodiments of the invention, certain steps can be performed in a different order, in parallel with one another, or omitted entirely, and/or certain additional steps can be performed without departing from the scope and spirit of the invention. The method 225 is described hereinafter with reference to FIGS. 1, 4, and 6-10.

The method 225 involves access to the virtual safe 122 by the user at access points 102, as described herein above with reference to FIG. 2. The virtual safe 122 receives user instructions throughout the method 225, and can perform the related functionality by accessing other virtual safe 122 accounts, the database server 112, the authorization engine 110, the trusted entity 120, and/or the external business entities 118.

In step 405, the user interface on the access point 102 displays the file detail, category and folder contents list, and space management indicator. Thus, the user can view a “snapshot” of the contents of the virtual safe 122 (the electronic media contents being stored on the file storage device 114). The application server 106 communicates with the database server 112 to access the information to be displayed by the virtual safe 122. The file detail displays the contents of the selected file in a pane of the display. For example, the file detail can display a financial statement, and/or a certificate of title. The user can select a different file to change the file detail pane and display the contents of a different file. The category and folder contents list displays a hierarchy of the folder categories, and the files and/or folders contained within each category. The space management indicator displays the current usage of the allotted space the user had on the virtual safe 122 and on the allotted storage space of the file storage device 114 and/or the file storage device mirror 116. In this way, a user can determine whether there is a need to delete files and/or acquire additional storage space, which will be described in more detail herein with reference to steps 465 and 475 of FIG. 4. Optionally, the display also can include a pane for the trusted entity 120 to display branded material, including the trusted entity's 120 logo and/or advertising material. A representative file management dashboard display 1000 is described in more detail herein with reference to FIG. 10.

In step 415, the user determines whether to customize the display 1000. Customization includes, for example, creating and/or renaming categories and/or folders.

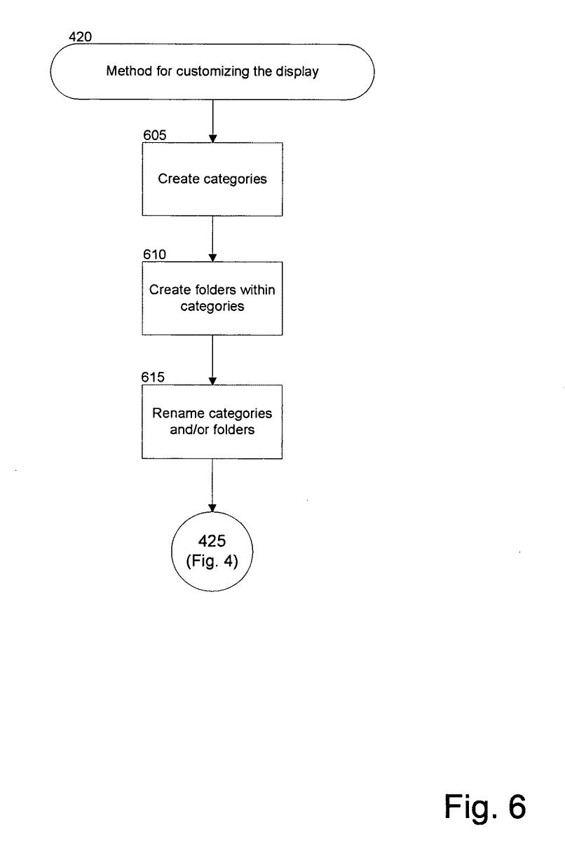

If, in step 415, the determination is made to customize the display 1000, the method proceeds to step 420. Step 420 is described in more detail herein with reference to FIG. 6.

In step 425, the user determines whether to manage files. Managing files includes, for example, uploading, downloading, renaming, and/or sorting files.

If, in step 425, the determination is made to manage files, the method proceeds to step 430. Step 430 is described in more detail herein with reference to FIG. 7.

In step 435, the user determines whether to search files. Searching files includes entering search criteria, for example, file name, to locate files stored by the virtual safe 122. The search mechanism will be described in more detail herein with reference to FIG. 10.

If, in step 435, the determination is made to search files, the method proceeds to step 440.

In step 440, the user searches for files. The search mechanism will be described in more detail herein with reference to FIG. 10.

In step 445, the user determines whether to administer sharees. A “sharee” is another virtual file safe user and/or account holder that has the capability, if approved, to access certain pre-selected files associated with another user. In other words, a sharee would be able to access files stored under another user's logon identification in the file storage device 114 through the virtual safe 122, if they are an approved sharee by the other user.

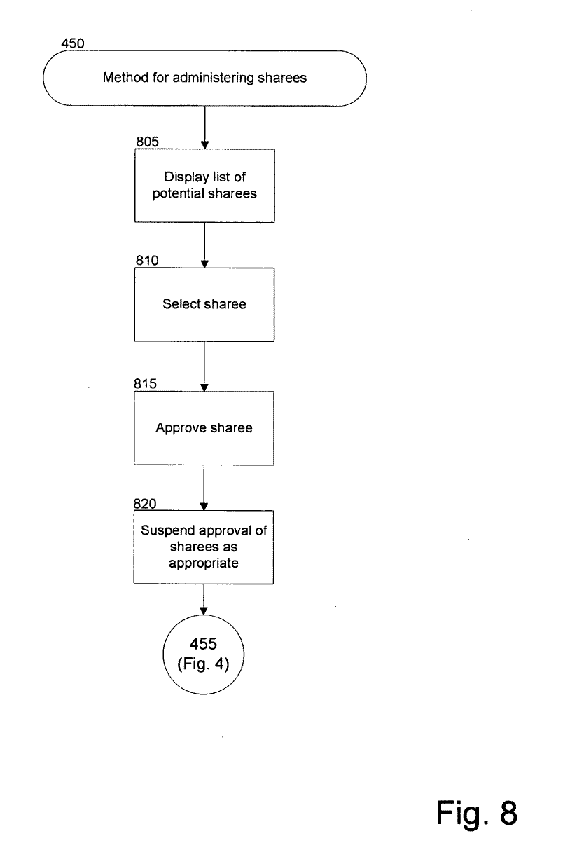

If, in step 445, the determination is made to administer sharees, the method proceeds to step 450. Step 450 is described in more detail herein with reference to FIG. 8.

In step 455, the user determines whether to share and/or unshare files and/or folders with sharees. Sharing provides access to a file and/or folder to an approved sharee. Unsharing involves removing access to a file and/or folder that was once shared with an approved sharee.

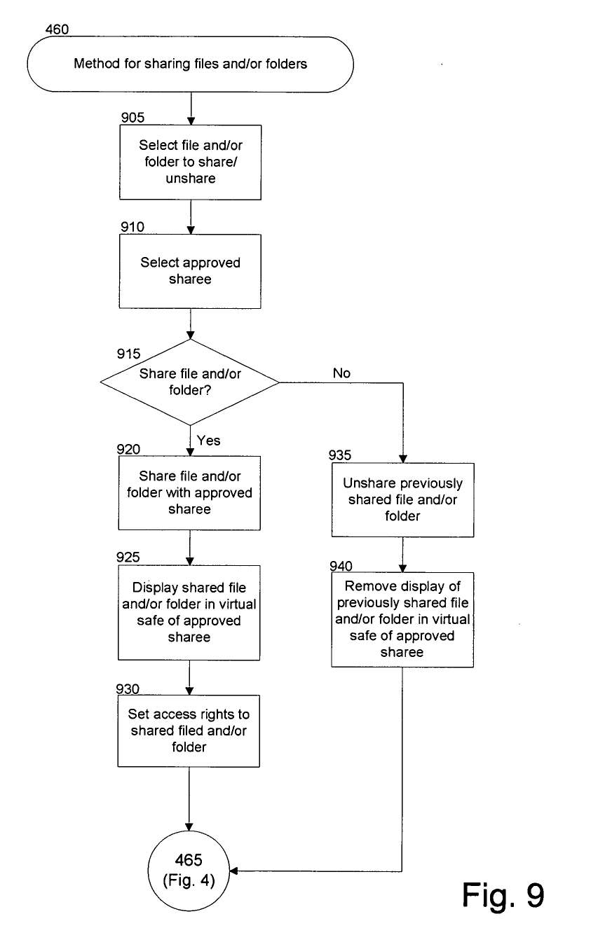

If, in step 455, the determination is made to share and/or unshare files and/or folders with sharees, the method proceeds to step 460. Step 460 is described in more detail herein with reference to FIG. 9.

In step 465, the user determines whether to acquire additional storage space. The space management indicator, as described herein with reference to step 405, displays the current usage of the allotted storage space to which the virtual safe 122 can access. Based on space management indicator, the user can determine whether to acquire additional storage space.

If, in step 465, the determination is made to acquire additional storage space, the method proceeds to step 470.

In step 470, the user specifies an amount of additional storage space to acquire. If the user is required to pay for the additional storage space, the user enters payment information in step 470, for example, credit card information. Thus, the user can acquire storage space greater than the amount initially allotted to the virtual safe 122.

In step 475, the user determines whether to manage the user profile. The user profile includes the information associated with the user, for example, user name, contact information, account information, and logon information.

If, in step 475, the determination is made to manage the user profile, the method proceeds to step 480. In step 480, the user can make changes to their profile. For example, the user can change the logon password, and/or change their address. The virtual safe 122 communicates with the authorization engine 110 to store and update the changes to the user profile. The method then proceeds to step 240 of FIG. 2.

Referring back to step 415, if the determination is made not to customize the display 1000, the method proceeds to step 425, as described previously herein.

Referring back to step 425, if the determination is made not to manage files, the method proceeds to step 435, as described previously herein.

Referring back to step 435, if the determination is made not to search files, the method proceeds to step 445, as described previously herein.

Referring back to step 445, if the determination is made not to administer sharees, the method proceeds to step 455, as described previously herein.

Referring back to step 455, if the determination is made not to share files and/or folders, the method proceeds to step 465, as described previously herein.

Referring back to step 465, if the determination is made not to acquire additional space, the method proceeds to step 475, as described previously herein.

Referring back to step 475, if the determination is made not to manage the user profile, the method proceeds to step 240 of FIG. 2.

FIG. 5 is a flow chart depicting a method 230 for providing a product administration dashboard as referenced in step 230 of FIG. 3, in accordance with an exemplary embodiment of the invention. The exemplary method 230 is illustrative and, in alternative embodiments of the invention, certain steps can be performed in a different order, in parallel with one another, or omitted entirely, and/or certain additional steps can be performed without departing from the scope and spirit of the invention. The method 230 is described hereinafter with reference to FIGS. 1-2, 4, 6, and 9.

In step 505, the administrator sets default settings for the virtual safe 122. Default settings include folder names and/or categories. For example, the default settings can include categories entitled “Insurance,” “Banking,” “Legal,” and “Automotive.” The user can adjust the default categories as described herein with reference to step 420 of FIG. 4 and FIG. 6.

In step 510, the administrator administers user enrollment. Administration of user enrollment includes establishing virtual safe 122 accounts for new users and/or addressing user issues with their virtual safe 122 accounts. The administrator can access the virtual safe 122 by way of the access points 102, which communicate with the application server 106 over a network 104, which interfaces with the web server 108.

In step 515, the administrator approves sharees. In addition to user approval of sharees, an administrator can approve sharees. For example, the administrator can approve an employee of the trusted entity 120 as an approved sharee, so as to enable communication and media sharing between the user and the trusted entity. For example, the administrator may approve a loan officer at the trusted entity 120 who is working with the user, in order to facilitate electronic document sharing between the user and the loan officer incident to a loan. In this way, the virtual safe 122 facilitates business transactions, increases their security, and ensures the confidence of the user. It also can eliminate paperwork, and help ensure that users have the most current documentation.

In step 520, the administrator manages storage space allotment. For example, the administrator can manage bill payment for additional disk space, and/or increase the storage space allotment for each user. An increase in storage space provides for an increase in the allotment of space on the file storage device 114.

In step 525, the administrator controls sharee access to shared files. For example, the administrator can determine the access rights for particular sharees. Access rights include the ability to perform functionality with regard to shared electronic media. They can include, for example, reading, downloading, writing, deleting, editing, and/or overwriting. The administrator can determine that, for example, due to the sensitive nature of certain files, sharees can only “read” the file, but cannot download the file. To restrict access capabilities, the administrator can access the virtual safe 122 accounts of the sharer and the sharee. As will be described hereinafter with reference to step 930 of FIG. 9, a user also can determine access rights.

In step 530, the administrator controls the encryption level of file storage. In an exemplary embodiment, the files contained in the file storage device 114 and/or the file storage device mirror 116 are stored with 128-bit encryption. A trusted entity 120 may wish to store the files with a higher or lower encryption level. Accordingly, and administrator can adjust the encryption level in step 530. In an exemplary embodiment, the administrator sends instructions to the application server 106 to interface with the database server 112 to adjust the encryption level. The method then proceeds to step 240 of FIG. 2.

FIG. 6 is a flow chart depicting a method 420 for customizing the display 1000 as referenced in step 420 of FIG. 4, in accordance with an exemplary embodiment of the invention. The exemplary method 420 is illustrative and, in alternative embodiments of the invention, certain steps can be performed in a different order, in parallel with one another, or omitted entirely, and/or certain additional steps can be performed without departing from the scope and spirit of the invention. The method 420 is described hereinafter with reference to FIG. 1-2, 5, and 10.

In step 605, a user creates categories in which to categorize the electronic folders. Categories are used herein to describe groups of folders that are associated in a logical way, based on the user preferences. For example, a category can be entitled “Car Titles,” “Bank Statements,” and/or “Insurance Policies,” and contain associated folders within each category. In addition, the categories can contain files not stored in a particular folder. In an exemplary embodiment, the virtual safe 122 can include default categories that exist prior to the user customizing the display 1000. Such default categories were discussed in more detail herein with reference to step 505 of FIG. 5. The user can maintain the default categories, delete the default categories, and/or create new categories. To customize categories, the user can access the virtual safe 122 as described herein with reference to step 210 of FIG. 2.

In step 610, the user creates folders within the categories in which to group electronic files. Folders can contain any number of electronic files, grouped in an associated way based on user preferences. For example, under a category for “Bank Statements,” the user can create separate folders for each bank account. As with categories, in an exemplary embodiment, the virtual safe 122 can include default folders that exist prior to the user customizing the display 1000. Such default folders were discussed in more detail herein with reference to step 505 of FIG. 5. The user can maintain the default folders, delete the default folders, and/or create new folders. To customize folders, the user can access the virtual safe 122 as described herein with reference to step 210 of FIG. 2.

In step 615, the user can rename the categories and folders described in steps 605 and 610. Accordingly, the virtual safe 122 display 1000 is customizable based on user preferences, and can reflect user changes such as the addition of bank accounts, car title, insurance policies, and the like. Renaming of categories and folders can be accomplished by the user accessing the virtual safe 122 as described herein with reference to step 210 of FIG. 2. The method then proceeds to step 425 of FIG. 4.

FIG. 7 is a flow chart depicting a method 430 for managing files as referenced in step 430 of FIG. 4, in accordance with an exemplary embodiment of the invention. The exemplary method 430 is illustrative and, in alternative embodiments of the invention, certain steps can be performed in a different order, in parallel with one another, or omitted entirely, and/or certain additional steps can be performed without departing from the scope and spirit of the invention. The method 430 is described hereinafter with reference to FIGS. 1-2, and 6-7.

In step 705, the user can upload files. Uploading files can include uploading from the user's hard drive, transmitting a file via an email, and/or transmitting a file via facsimile transmission. For example, if the user is accessing the virtual safe 122 from the user's personal computer via an access point 102 on the trusted entity's website, the user can select a file from their personal computer's hard drive to upload to the virtual safe 122. For example, the user can upload electronic images of personal documents, such as a will, a birth certificate, and/or a passport. The virtual safe 122 receives the instructions from the user to upload the file via the web server 108, which is logically connected to the access point 102 via the network 104. In an exemplary embodiment, the user can associate an email address with their registration information, such that an email from the designated email address will automatically be associated with the user's virtual safe 122 account. In this way, the virtual safe 122 can automatically upload any file attached to an e-mail received from the designated e-mail address for storage on the file storage device 114 and associated with the user's account. Similarly, the user can associate a facsimile number with their registration information, such that facsimile transmissions from the designated number are automatically uploaded to and associated with the user's virtual safe 122 account and stored on the file storage device 114. In yet another embodiment, a bar code, containing information that identifies the user's account, can be used to automatically upload information that is received via facsimile or another mode of transmission. In this embodiment, the machine-readable bar code can be translated to obtain the information identifying the user's account, and the document can be automatically uploaded to and associated with the user's virtual safe 122 account and stored on the file storage device 114. The virtual safe 122 receives and stores uploaded files in the file storage device 114 as described herein with reference to step 240 of FIG. 2. In an alternative embodiment, the user can upload files to the virtual safe 122 from an external computer system, such as an external business entity 118. In this alternative embodiment, the user can select files located on the computer system of the external business entity 118, and upload them directly to the virtual safe 122.

In step 710, the user can download files stored by the virtual safe 122 in the file storage device 114. The user typically downloads files to the user's personal hard drive, described herein with reference to step 705 of FIG. 7. Accordingly, the user can obtain a local copy of files as needed. For example, the user may wish to download the electronic file for editing pursuant to a financial transaction. Upon completion of editing, the user may then upload the edited document back to the virtual safe 122 by way of the uploading method described about with reference to step 705 of FIG. 7. Thus, the ability to upload and download can facilitate communication between an authorized user of the virtual safe 122 and any approved sharees. This can ensure security of the electronic files, while facilitating collaboration and reduce paperwork. The user can download files from the virtual safe 122 by accessing access points 102, as described herein with reference to step 240 of FIG. 2.

In step 715, the user can move files to and from another folder or category. Folders and categories were described herein with reference to FIG. 6. Accordingly, the user can sort the electronic files based on user preferences. The user can move files accessible by the virtual safe 122 by accessing access points 102, as described herein with reference to step 240 of FIG. 2.

In step 720, the user can delete files. Deleting files moves the files to a recycle bin. When the recycle bin is purged, the files are permanently removed from the virtual safe 122, and the associated file storage device 114 and the file storage device mirror 116. Users can delete files at any time, thus the virtual safe 122 allows for customization of the length of storage time for each file. Deleting files allows users to optimize storage space, by deleting, for example, files that are no longer important to the user. The user can delete files accessible by the virtual safe 122 by accessing access points 102, as described herein with reference to step 240 of FIG. 2.

In step 725, the user can sort files based on various criteria. For example, the user can sort files based on size, name of folder, date modified, description, and other file attributes. The user can sort files accessible by the virtual safe 122 by accessing access points 102, as described herein with reference to step 240 of FIG. 2. The method then proceeds to step 435 of FIG. 4.

FIG. 8 is a flow chart depicting a method 450 for administering sharees as referenced in step 450 of FIG. 4, in accordance with an exemplary embodiment of the invention. The exemplary method 450 is illustrative and, in alternative embodiments of the invention, certain steps can be performed in a different order, in parallel with one another, or omitted entirely, and/or certain additional steps can be performed without departing from the scope and spirit of the invention. The method 450 is described hereinafter with reference to FIGS. 1-2, 4-5, 9, and 10.

In step 805, the virtual safe 122 displays a list of potential sharees on the display 1000. The list of potential sharees can include, for example, other authorized users having a virtual safe 122 account. The virtual safe 122 can access the authorization engine 110 to determine the list of potential sharees to display. An administrator can determine the list of potential sharees, as described herein with reference to step 515 of FIG. 5. For example, the potential sharees can comprise a subset of representatives of the trusted entity 120, and/or family members associated with the authorized user. The list of potential sharees is displayed via an interface displayed on a workstation associated with the access point 102.

In step 810, the user selects a sharee from the list displayed in step 805. The user can select the user by, for example, clicking on the display using a computer mouse. The user can select a sharee by accessing an access point 102, as described herein with reference to step 240 of FIG. 2.

In step 815, the user approves the sharee. In an exemplary embodiment, the virtual safe 122 prompts the user, via an interface, as described herein with reference to step 805, to confirm approval of the sharee. An approved sharee is another virtual safe 122 account holder, with whom the authorized user has the capability to share electronic files and/or folders. The sharing and unsharing of electronic files and/or folders is described in more detail herein with reference to FIG. 9.

In step 820, the user can suspend approval of the approved sharees. For example, if an individual is no longer associated with the authorized user, the user may wish to suspend their status as an approved sharee. The user can suspend approval by selecting the approved sharee from a list displayed by the virtual safe 122 on an interface, as described above with reference to step 805. The method then proceeds to step 455 of FIG. 4.

FIG. 9 is a flow chart depicting a method 460 for sharing and/or unsharing files and/or folders as referenced in step 460 of FIG. 4, in accordance with an exemplary embodiment of the invention. The exemplary method 460 is illustrative and, in alternative embodiments of the invention, certain steps can be performed in a different order, in parallel with one another, or omitted entirely, and/or certain additional steps can be performed without departing from the scope and spirit of the invention. The method 460 is described hereinafter with reference to FIGS. 1, 8, and 10.

In step 905, the user selects the file and/or folder to share and/or unshare. In an exemplary embodiment, the user can select the file and/or folder by clicking on the folder displayed on the interface, as described herein above with reference to step 805 of FIG. 8. For example, the user can select multiple files and/or folders for sharing by placing a checkmark in the box next to the file and/or folder as it is displayed the display 1000, which will be described in more detail hereinafter with reference to FIG. 10.

In step 910, the user selects an approved sharee with whom to share the selected files and/or folders. If the user wishes to unshare a file and/or folder, the user selects the approved sharees with whom the files and/or folders are currently being shared. In an exemplary embodiment, the display 1000 includes a list of approved sharees, and the user can select an approved sharee by clicking on an approved sharee using a computer mouse.

In step 915, the user determines whether to share or unshare the selected files and/or folders with the selected approved sharee.

If, in step 915, the determination is made to share files, the method proceeds to step 920.

In step 920, the virtual safe 122 shares the selected files and/or folders with the approved sharee. In an exemplary embodiment, the virtual safe 122 can share the selected files and/or folders with the approved sharee by associating the selected files and/or folders with an account of the sharee in the file storage device 114. Accordingly, the selected files and/or folders can be available to the sharee when the sharee properly accesses the sharee's account.

In step 925, the virtual safe 122 displays the shared files and/or folders on the virtual safe 122 display 1000 associated with the approved sharee. In an exemplary embodiment, the shared files and/or folders can be displayed under a category entitled “Shared Folders,” within which each folder is entitled with the name of the sharer, or user sharing the file. Accordingly, the approved sharee can quickly assess the files have been shared with them, and by whom. In an exemplary embodiment, remove from display.

In step 930, the user sets the access rights for the approved sharee to the shared file and/or folder. As described herein above with reference to step 525 of FIG. 5, access rights can include the ability to read, write, and/or download. Accordingly, a user can restrict access to the shared file to only reading capability. Thus, a user and/or an administrator can control the access rights.

Referring back to step 915, if the determination is made to unshare a previously shared file and/or folder, the method proceeds to step 935.

In step 935, the virtual safe 122 unshares the selected files and/or folders with the approved sharee selected in step 910. The virtual safe 122 of the user communicates with the virtual safe 122 account held by the approved sharee.

In step 940, the virtual safe 122 removes from the display 1000 associated with the approved sharee, the file and/or folder that is no longer being shared. Accordingly, a user can quickly and efficiently control access to his or her files, by sharing and unsharing the files. The method then proceeds to step 465 of FIG. 4.

FIG. 10 is a screenshot depicting a representative display 1000 of the file management dashboard, in accordance with an exemplary embodiment of the invention. As shown in FIG. 10, the display 1000 includes a category and folder list 1005. The categories and folders were described herein with reference to FIG. 6. The representative category and folder list 1005 includes categories entitled “Policies,” “Car Titles,” and “Legal Documents.” The folders under the categories include, for example, under the category “Policies,” folders for “Auto,” “Home,” “Boat,” and “Life.” As displayed in FIG. 10, the category and folder list 1005 provides an efficient display of the contents of the virtual safe 122, while not encompassing a large amount of space on the display 1000. It also provides a customizable display, thus making it easier for the user to store, sort, and view important documents. The category and folder list 1005 is a scrollable pane.

The display 1000 also includes a file detail pane 1010. The file detail pane 1010 displays the actual content of the selected file. For example, as shown in FIG. 10, the file detail pane 1010 displays a certificate of title, which is a file contained within the category “Car titles.” The user can select the file to be displayed by, for example, clicking a computer mouse cursor on the file as it displayed in the folder contents list 1015 (discussed below). The file detail pane 1005, like the category and folder list 1005, is a scrollable pane, allowing the user to view the entirety of a file by scrolling.

The display 1000 also includes a folder contents list 1015. The folder contents list 1015 contains a listing of the contents of a selected category or folder. In the representative folder contents list 1015, the contents of the category “Car Titles” is displayed.

The space management indicator 1020 is also included in the display 1000. In this exemplary embodiment, the space management indicator 1020 includes a thermometer-like gauge that visually depicts the amount of space currently being used, and the remaining available space. In the representative space management indicator 1020, the virtual safe 122 is using 30% of the available space. Also included in the space management indicator 1020 is an icon to acquire additional space, as represented by the shopping cart icon and link to “Buy More Storage.”

The display 1000 also includes a branding pane 1025. In the branding pane 1025, a trusted entity 120 controlling and running the application server 106 and virtual safe 122 can display branded content, such as a bank logo. As another example, the trusted entity 120 can display advertising for its product and service offerings.

The display 1000 also includes a file management pane 1030. The file management pane 1030 includes links, buttons, and other tools used to perform the file management and customization functions described herein with reference to FIGS. 4, 6, and 7. As shown, the representative file management pane 1030 includes buttons to upload, download, create a new folder, move a file and/or folder, rename a file and/or folder, and delete a file and/or folder. In addition, the file management pane 1030 includes a search box, allowing a user to search for files by name and/or type.

Although specific embodiments of the invention have been described above in detail, the description is merely for purposes of illustration. It should be appreciated, therefore, that many aspects of the invention were described above by way of example only and are not intended as required or essential elements of the invention unless explicitly stated otherwise. Various modifications of, and equivalent steps corresponding to, the disclosed aspects of the exemplary embodiments, in addition to those described above, can be made by a person having ordinary skill in the art without departing from the spirit and scope of the invention defined in the following claims, the scope of which is to be accorded the broadest interpretation so as to encompass such modifications and equivalent structures.

What is claimed:

1. A method for secure remote storage of electronic media, comprising the steps of:
receiving a plurality of electronic media;
storing the plurality of electronic media in a file storage device;
preventing access to the plurality of electronic media from unauthorized users;
customizing a display of the plurality of electronic media; and
sharing a subset of the plurality of the electronic media with an approved sharee, the subset of the plurality of the electronic media being associated with an account of the approved sharee.

2. The method of claim 1, wherein the storing step comprises storing the plurality of electronic media in an encrypted format.

3. The method of claim 1, wherein the preventing step comprises associating a logon identification and a logon password with an authorized user, and providing access to the plurality of electronic media to the authorized user.

4. The method of claim 1, wherein the customizing step comprises displaying information associated with the plurality of electronic media on an interface.

5. The method of claim 1, wherein the customizing step comprises creating one or more user-selected categories and categorizing the plurality of electronic media within the one or more user-selected categories.

6. The method of claim 5, wherein the receiving step comprises automatically uploading the plurality of electronic media from a computer system of a trusted entity into the one or more user-selected categories, wherein the automatic uploading occurs by way of a batch interface between the trusted entity and an application server associated with the file storage device.

7. The method of claim 6, wherein the plurality of electronic media automatically uploaded from the computer system of the trusted entity comprises electronic media associated with an account held by the authorized user with the trusted entity.

8. The method of claim 6, wherein the trusted entity comprises at least one of a bank, an insurance company, and a financial entity.

9. The method of claim 1, wherein the sharing step comprises the steps of:
selecting a user;
approving the user, wherein an approved user is an approved sharee;
selecting the subset of the plurality of electronic media; and
providing the approved sharee electronic access to the subset of the plurality of electronic media;

10. The method of claim 9, wherein the providing step comprises restricting one or more access capabilities of the approved sharee to the subset of the plurality of electronic media, the one or more access capabilities comprising reading, writing, uploading, downloading, overwriting, and deleting.

11. The method of claim 1, further comprising the steps of:
determining whether to discontinue sharing the subset of electronic media; and
in response to a determination to discontinue sharing the subset of electronic media, preventing access to the subset of electronic media by the approved sharee.

12. The method of claim 1, wherein the sharing step facilitates efficient collaboration among authorized users and approved sharees pursuant to a financial transaction, an insurance transaction, a business matter, and a personal matter.

13. The method of claim 1, wherein the approved sharee comprises one or more of an employee of the trusted entity, a representative of a third party entity, and an individual.

14. The method of claim 1, further comprising the step of managing the plurality of electronic media, wherein managing comprises at least one of uploading, downloading, deleting, moving, sorting, and searching.

15. The method of claim 14, wherein uploading comprises transmitting the plurality of electronic media from one of an external computer system, an e-mail system, and a facsimile transmission to the file storage device, and downloading comprises storing the plurality of electronic media to an external computer system.

16. The method of claim 1, further comprising the step of acquiring additional storage space in the file storage device associated with the authorized user to store the plurality of electronic media associated with the authorized user.

17. The method of claim 1, wherein the plurality of electronic media comprises at least one of a financial-, business-, legal-, family-, and insurance-related electronic files.

18. A system for secure remote storage of electronic media, comprising:
an application server that receives a plurality of electronic media, associates the plurality of electronic media with a first authorized user, receives instructions from the first authorized user relating to sharing an item of the plurality of electronic media with a second authorized user, and associates the item of electronic media with the second authorized user, wherein the application server receives a portion of the electronic media from the first authorized user and another portion of the electronic media from a trusted entity; and
an authorization engine that allows access to the plurality of electronic media by the first authorized user via a first account associated with the first authorized user and that allows access to the item of the plurality of electronic media by the second authorized user via a second account associated with the second authorized user.

19. The system of claim 18, further comprising a file storage device logically connected to the application server and operable to store the plurality of the electronic media.

20. The system of claim 18, further comprising a plurality of access points logically connected to the application server, wherein the authorization engine allows access to the plurality of electronic media by the first authorized user via a first one of the access points, and wherein the authorization engine allows access to the item of the plurality of electronic media by the second authorized user via a second one of the access points.

21. The system of claim 18, wherein the application server receives instructions from the first authorized user to associate the item of the plurality of electronic media with the second authorized user.

22. The system of claim 18, wherein access to the plurality of electronic media by the first authorized user and to the item of electronic media by the second authorized user comprises displaying at least a portion of the respective electronic media.

23. The method of claim 22, wherein the displaying comprises displaying at least one of a file detail pane, a space management indicator, a folder and category list, a folder contents list, a branding pane, a file management pane, and a search box.

24. The system of claim 21, wherein in response to receipt of instructions from the first authorized user to share the item of electronic media with the second authorized user, the application server performs the following steps:
identifying the item of electronic media to be shared;
identifying the second authorized user with whom to share the item of electronic media;
displaying the item of electronic media on an interface to which the second authorized user has access; and
providing access to the item of electronic media to the second authorized user.

25. The system of claim 24, wherein the step of providing access to the item of electronic media comprises restricting at least one access capability of the second authorized user, the at least one access capability comprising at least one of reading, writing, uploading, downloading, overwriting, and deleting.

26. The system of claim 18, wherein the plurality of electronic media comprises at least one of a financial-, business-, legal-, family-, and insurance-related electronic file.

27. A method for secure remote storage of electronic media, comprising the steps of:
storing a plurality of electronic media, a portion of the electronic media being received from a first authorized user, and another portion of the electronic media being received from a trusted entity;
displaying content associated with the plurality of electronic media to the first authorized user;
receiving instructions to share an item of the electronic media with a second authorized user; and
displaying content associated with the item of electronic media to the second authorized user.

28. The method of claim 27, wherein the instructions received in the receiving step comprise access rights that establish capabilities of the second authorized user with respect to the item of electronic media.

29. The method of claim 27, wherein the trusted entity comprises one of a bank, an insurance company, and a financial entity.

30. The method of claim 27, further comprising the step of customizing the display of the electronic media by at least one of creating a file, creating a folder, creating a category, renaming a file, renaming a folder, and renaming a category.

31. The method of claim 27, wherein the displaying steps comprise at least one of displaying a file detail pane, a space management indicator, a folder and category list, a folder contents list, a branding pane, a file management pane, and a search box.

32. The method of claim 27, wherein the plurality of electronic media comprises at least one of a financial-, business-, legal-, family-, and insurance-related electronic file.

33. The method of claim 27, further comprising the steps of:
associating one or more of an email address, a facsimile number, and a bar code with the first authorized user;
automatically storing an item of electronic media received from one of the email address and the facsimile number; and
automatically storing the item of electronic media comprising the bar code.
